(19) United States
(12) Patent Application Publication
(10) Pub. No.: US 2026/0095412 A1
(43) Pub. Date: Apr. 2, 2026

(54) NETWORK PACKET PROCESSING DEVICE WITH EXPLICIT CONGESTION NOTIFICATION MARKING AIDED BY NETWORK PROCESSING UNIT AND RELATED NETWORK PACKET PROCESSING METHOD

(71) Applicant: Airoha Technology (Suzhou) Limited, Suzhou City (CN)

(72) Inventors: Weihua Huang, Nanjing City (CN); Fei Yan, Nanjing City (CN); Peng Du, Nanjing City (CN)

(73) Assignee: Airoha Technology (Suzhou) Limited, Suzhou City (CN)

(21) Appl. No.: 19/325,466

(22) Filed: Sep. 10, 2025

(30) Foreign Application Priority Data
Sep. 29, 2024 (CN) 202411367649.7

(51) Int. Cl. H04L 47/24; H04L 47/12; H04L 47/625

(52) U.S. Cl. CPC H04L 47/24; H04L 47/12; H04L 47/6255

(57) ABSTRACT

A network packet processing device includes a hardware-accelerated forwarding circuit and a network processing unit (NPU). The hardware-accelerated forwarding circuit is used to receive a plurality of L4S packets from a network port and send the plurality of L4S packets to another network port through hardware-accelerated forwarding without intervention of a central processing unit (CPU). The NPU is used to perform ECN marking on at least a portion of the plurality of L4S packets.

### BACKGROUND OF THE INVENTION

### 1. Field of the Invention

The present invention relates to network packet forwarding, and more particularly, to a network packet processing device utilizing a network processing unit (NPU) to assist in processing explicit congestion notification (ECN) marking for Low Latency, Low Loss, Scalable Throughput (L4S) packets and a related network packet forwarding method.

### 2. Description of the Prior Art

A gateway is a common network device used to connect different networks and forward packets from one network to another. For example, the gateway may forward packets between a local area network (LAN) and a wide area network (WAN). Generally speaking, the gateway may support legacy congestion avoidance mechanisms, which primarily use packet loss as an indication signal of network congestion, thereby instructing the sender to reduce the sending rate to avoid network congestion. However, legacy congestion avoidance mechanisms can introduce large latency, throughput fluctuation, and bandwidth waste in high-speed network environments. L4S is a new congestion control mechanism that uses a header of a network packet to transmit ECN as an indication signal of network congestion, which allows the sender to adjust the sending rate before network congestion begins, rather than after packet loss occurs. In this way, the network bandwidth can be fully utilized without incurring large latency and packet loss. Therefore, if the gateway supports L4S, it can benefit from L4S′ advantages including latency reduction and network performance improvement. However, if the gateway's central processing unit (CPU) is responsible for processing ECN marking of L4S packets, this will occupy limited CPU resources and cause degradation of the overall gateway performance. Thus, there is a need for an innovative L4S congestion handling architecture capable of effectively processing ECN marking of L4S packets.

### SUMMARY OF THE INVENTION

One of the objectives of the claimed invention is to provide a network packet processing device utilizing an NPU to assist in processing ECN marking for L4S packets and a related network packet forwarding method.

According to a first aspect of the present invention, an exemplary network packet processing device is disclosed. The exemplary network packet processing device includes a hardware-accelerated forwarding circuit and a network processing unit (NPU). The hardware-accelerated forwarding circuit is configured to receive a plurality of Low Latency, Low Loss, Scalable Throughput (L4S) packets from a network port, and send the plurality of L4S packets to another network port through hardware-accelerated forwarding, without intervention of a central processing unit (CPU). The NPU is configured to perform explicit congestion notification (ECN) marking on at least a portion of the plurality of L4S packets.

According to a second aspect of the present invention, an exemplary network packet processing method is disclosed. The exemplary network packet processing method includes: receiving a plurality of Low Latency, Low Loss, Scalable Throughput (L4S) packets from a network port; sending the plurality of L4S packets to another network port through hardware-accelerated forwarding, without intervention of a central processing unit (CPU); and performing, by a network processing unit (NPU), explicit congestion notification (ECN) marking on at least a portion of the plurality of L4S packets.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a network packet processing device according to an embodiment of the present invention.

FIG. 2 is a flowchart of a queue monitoring method according to an embodiment of the present invention.

FIG. 3 is a flowchart of a traffic monitoring method according to an embodiment of the present invention.

FIG. 4 is a flowchart of an ECN marking probability calculation method according to an embodiment of the present invention.

FIG. 5 is a flowchart of an ECN marking method according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

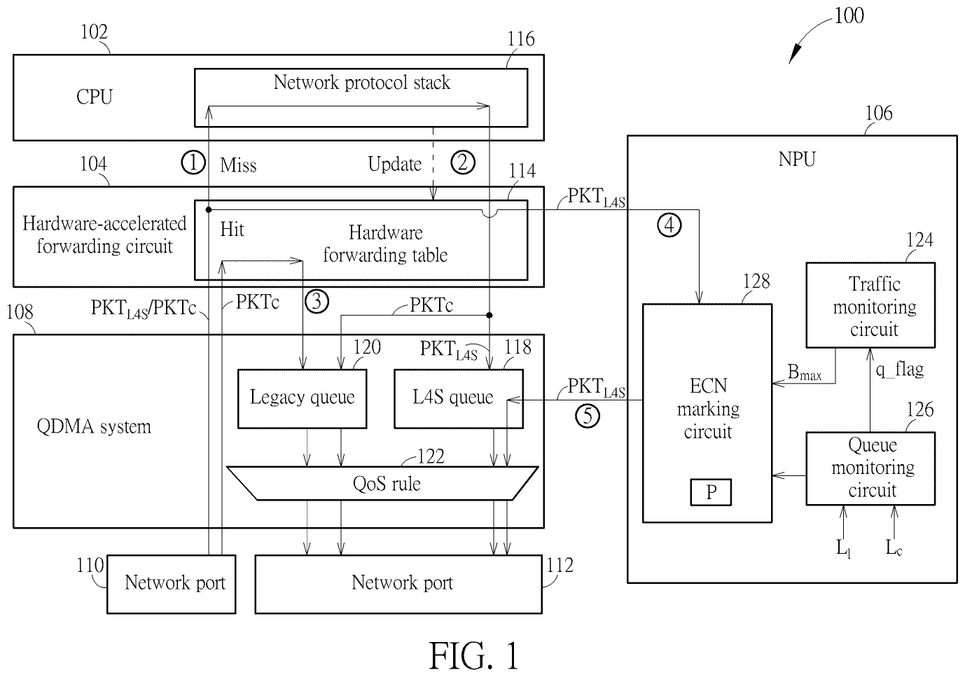

FIG. 1 is a diagram of a network packet processing device according to an embodiment of the present invention. For example, the network packet processing device 100 may be employed by a network device, such as a gateway. As shown in FIG. 1, the network packet processing device 100 may include a CPU 102, a hardware-accelerated forwarding circuit (also called frame engine) 104, an NPU 106, a queue direct memory access (QDMA) system 108, and a plurality of network ports 110 and 112. Please note that only the components pertinent to the present invention are illustrated in FIG. 1. In practice, the network packet processing device 100 may include additional components to achieve designated functions.

In this embodiment, the network port 110 serves as a receive (RX) port, and the network port 112 serves as a transmit (TX) port. For example, the network packet processing device 100 receives packets, including L4S packets and legacy packets, from the LAN via the network port 110, and forwards the packets, including L4S packets PKT_{L4S} and legacy packets PKT_{C}, to the WAN via the network port 112. The hardware-accelerated forwarding circuit 104 includes a hardware forwarding table 114. When a packet (e.g., L4S packet PKTL4S or legacy packet PKT_{C}) received by the network port 110 does not hit a forwarding rule recorded in any table entry in the hardware forwarding table 114, the hardware-accelerated forwarding circuit 104 hands over the packet (e.g., L4S packet PKT_{L4S} or legacy packet PKT_{C}) to the CPU 102 for packet forwarding, as illustrated by a circled number “1”. The CPU 102 executes a software module (e.g., a network protocol stack 116) to deal with forwarding of this packet (e.g., L4S packet PKT_{L4S} or legacy packet PKT_{C}). The legacy packet PKT_{C} is a packet that does not support L4S. Therefore, the CPU 102 distinguishes between the L4S packet PKT_{L4S} and the legacy packet PKT_{C}, pushes them into the L4S queue 118 and the legacy queue 120 in the QDMA system 108, respectively, and updates the hardware forwarding table 114 so that subsequent packets can be directly processed by a hardware-accelerated forwarding function of the hardware-accelerated forwarding circuit 104 without intervention of the CPU 102, as illustrated by a circled number “2”.

When the legacy packet PKT_{C} received by the network port 110 hits a forwarding rule recorded in a certain table entry in the hardware forwarding table 114, the hardware-accelerated forwarding circuit 104 sends the legacy packet PKT_{C} to the network port 112 through its own hardware-accelerated forwarding function without intervention of the CPU 102. Specifically, the hardware-accelerated forwarding circuit 104 pushes the legacy packet PKT_{C} into the legacy queue 120 in the QDMA system 108. The multiplexer 122 in the QDMA system 108 retrieves the to-be-transmitted legacy packet PKT_{C} from the legacy queue 120 according to the quality of service (QoS) rule and sends it to the network port 112 to complete the packet forwarding task, as illustrated by a circled number “3”. For example, the QoS rule (i.e., QoS queue scheduling) between the L4S queue 118 and the legacy queue 120 may adopt Strict-Priority (SP) scheduling or Weighted Round Robin (WRR) scheduling, but the present invention is not limited thereto.

When the L4S packet PKT_{L4S} received by the network port 110 hits a forwarding rule recorded in a certain table entry in the hardware forwarding table 114, the hardware-accelerated forwarding circuit 104 deals with forwarding of the L4S packet PKT_{L4S} through its own hardware-accelerated forwarding function without intervention of the CPU 102. In this embodiment, the hardware-accelerated forwarding circuit 104 utilizes the NPU 106 to assist in processing an ECN marking task, as illustrated by a circled number “4”. Therefore, the NPU 106 performs ECN marking on at least a portion (i.e., part or all) of a plurality of L4S packets that hit the hardware forwarding table 114, to effectively address the network congestion issue, as illustrated by a circled number “5”. The multiplexer 112 of the QDMA system 108 then retrieves the to-be-transmitted L4S packet PKT_{L4S} from the L4S queue 118 according to the QoS rule, and sends it to the network port 112 to complete the packet forwarding task.

The NPU 106 is a high-speed programmable processor specifically designed for network packet processing (e.g., network packet forwarding). It has features and architecture specifically designed to accelerate network packet processing efficiency. In this embodiment, the NPU 106 may include a traffic monitoring circuit 124, a queue monitoring circuit 126, and an ECN marking circuit 128. The queue monitoring circuit 126 is configured to monitor the L4S queue 118 and the legacy queue 120 to generate a monitoring result q_flag. The traffic monitoring circuit 124 is configured to monitor the maximum bandwidth Bₘₐₓ of the network port (i.e., TX port) 112, and provide a current value of the maximum bandwidth Bₘₐₓ to the ECN marking circuit 128, where an update of the maximum bandwidth Bₘₐₓ of the network port 112 depends on the monitoring result q_flag generated by the queue monitoring circuit 126. The ECN marking circuit 128 is configured to calculate an ECN marking probability P according to at least the maximum bandwidth Bₘₐₓ of the network port 112 that is provided by the traffic monitoring circuit 124, and to perform ECN marking on at least a portion (i.e., part or all) of a plurality of L4S packets that hit the hardware forwarding table 114 according to the ECN marking probability P. For example, the ECN marking circuit 128 may set ECN bits included in a header of an L4S packet to indicate the impending network congestion.

The present invention supports L4S congestion control mechanisms through the collaborative operation of software and existing hardware, which eliminates the need for hardware upgrades and does not increase the CPU load. The details of the NPU 106 assisting in processing ECN marking of L4S packets are described as below with reference to the accompanying flowcharts.

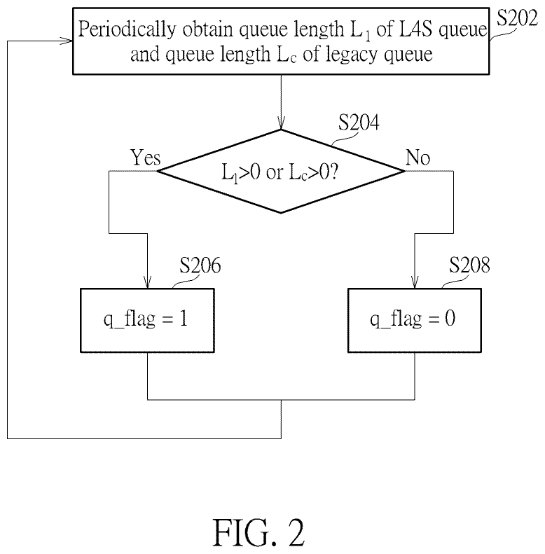

FIG. 2 is a flowchart of a queue monitoring method according to an embodiment of the present invention. The queue monitoring method may be performed by the queue monitoring circuit 126 shown in FIG. 1. Furthermore, provided that the result is substantially the same, the steps are not required to be executed in the exact order shown in FIG. 2. In step S202, the queue monitoring circuit 126 periodically obtains a queue length Lₗ of the L4S queue 118 and a queue length L_{c} of the legacy queue 120 from the QDMA system 108. The queue length Lₗ indicates the number of L4S packets that are buffered in the L4S queue 118 and waiting to be transmitted, and the queue length L_{c} indicates the number of legacy packets (i.e., packets not supporting L4S) that are buffered in the legacy queue 120 and waiting to be transmitted. If the network is not congested, L4S packets entering the L4S queue 118 will be read and sent out quickly, and legacy packets entering the legacy queue 120 will also be read and sent out quickly. However, if the network is congested, L4S packets entering L4S queue 118 may need to wait for a period of time before being transmitted, and/or legacy packets entering legacy queue 120 may need to wait for a period of time before being transmitted. In step S204, the queue monitoring circuit 126 checks whether one of queue length Lc and queue length L1 is a non-zero value. If one of queue length Lc and queue length L1 is a non-zero value, the queue monitoring circuit 126 sets the monitoring result q_flag by a logic value “1” (step S206), indicating that the network is about to be congested. If both queue length L_{c} and queue length Lₗ are zero values, the queue monitoring circuit 126 sets the monitoring result q_flag by a logic value “0” (step S208), indicating that the network is not currently congested.

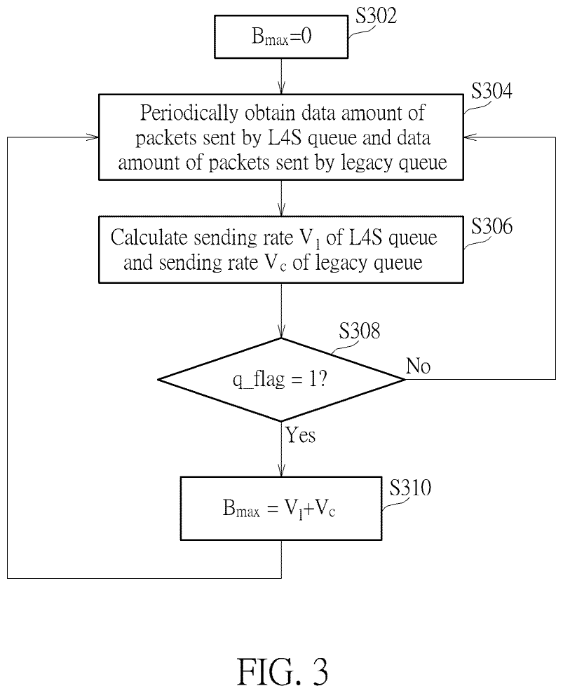

FIG. 3 is a flowchart of a traffic monitoring method according to an embodiment of the present invention. The traffic monitoring method may be performed by the traffic monitoring circuit 124 shown in FIG. 1. Furthermore, provided that the result is substantially the same, the steps are not required to be executed in the exact order shown in FIG. 3. In step S302, the traffic monitoring circuit 124 initially sets the maximum bandwidth Bₘₐₓ of the network port 112 by an initial value (e.g., Bₘₐₓ=0). In step S304, the traffic monitoring circuit 124 periodically (e.g., every period T) obtains data amount information from the QDMA system 108, where the data amount information includes the data amount of packets sent by the L4S queue 118 during one period T and the data amount of packets sent by the legacy queue 120 during one period T. Next, in step S306, the traffic monitoring circuit 124 calculates a sending rate Vₗ of the L4S queue 118 according to the data amount of packets sent by the L4S queue 118 and the length of the period T, and calculates a sending rate V_{c} of the legacy queue 120 according to the data amount of packets sent by the legacy queue 120 and the length of the period T. In step S308, the traffic monitoring circuit 124 checks whether the monitoring result q_flag provided by the queue monitoring circuit 126 has a logic value “1”. If the monitoring result q_flag has a logical value “0”, indicating that the network is not currently congested, the traffic monitoring circuit 124 keeps the maximum bandwidth Bₘₐₓ of the network port 112 unchanged. In other words, the traffic monitoring circuit 124 does not update the current value of the maximum bandwidth Bₘₐₓ, and the flow then returns to step S304 to perform traffic monitoring for the next period. If the monitoring result q_flag has a logical value “1”, indicating that the network is about to be congested, the traffic monitoring circuit 124 updates the maximum bandwidth Bₘₐₓ of the network port 112 by the sum of the current sending rate Vₗ of the L4S queue 118 and the current sending rate V_{c} of the legacy queue 120 (i.e., Bₘₐₓ=Vₗ+V_{c}), and the flow then returns to step S304 to perform traffic monitoring for the next period.

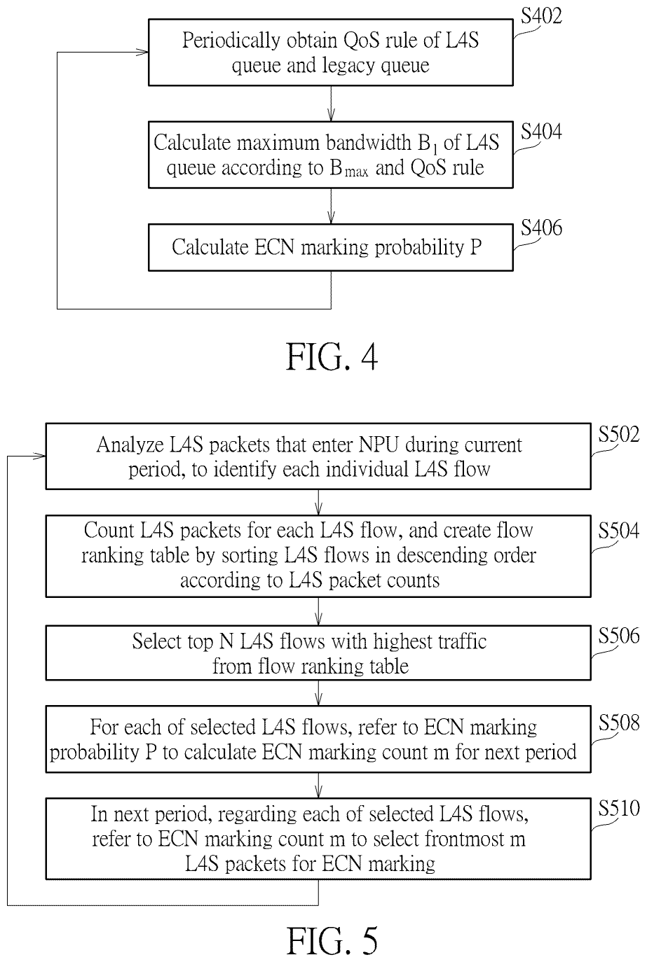

FIG. 4 is a flowchart of an ECN marking probability calculation method according to an embodiment of the present invention. The ECN marking probability calculation method may be performed by the ECN marking circuit 128 shown in FIG. 1. Furthermore, provided that the result is substantially the same, the steps are not required to be executed in the exact order shown in FIG. 4. In step S402, the ECN marking circuit 128 periodically (e.g., every period T) obtains the QoS rule (e.g., an SP scheduling setting or a WRR scheduling setting) of the L4S queue 118 and the legacy queue 120 from the QDMA system 108. In this embodiment, L4S traffic and legacy traffic can share the network bandwidth, and the QoS rule followed by both of L4S traffic and legacy traffic can be adjusted to meet different QoS requirements.

In step S404, the ECN marking circuit 128 calculates the maximum bandwidth Bₗ of the L4S queue 118 according to the maximum bandwidth Bₘₐₓ Of the network port 112 that is provided by the traffic monitoring circuit 124 and the QoS rule that is provided by the QDMA system 108. In one example, assuming that the QoS rule currently uses an SP scheduling setting and the priority of the L4S queue 118 is higher than the priority of the legacy queue 120, the ECN marking circuit 128 sets the maximum bandwidth Bₗ of the L4S queue 118 by the current value of the maximum bandwidth Bₘₐₓ of the network port 112 (i.e., Bₗ=Bₘₐₓ). In another example, assuming that the QoS rule currently uses a WRR scheduling setting and weights of L4S queue 118 and legacy queue 120 are both 50%, the ECN marking circuit 128 sets the maximum bandwidth Bₗ of L4S queue 118 by the current value of the maximum bandwidth Bₘₐₓ of network port 112 multiplied by the weight 50% of L4S queue 118 (i.e., Bₗ=0.5*Bₘₐₓ). Please note that these are for illustrative purposes only, and are not meant to be limitations of the present invention.

In step S406, the ECN marking circuit 128 calculates the ECN marking probability P. In one embodiment, the ECN marking circuit 128 calculates the ECN marking probability P according to at least the traffic information. For example, the ECN marking circuit 128 calculates a ratio of the sending rate Vₗ of the L4S queue 118 (which is obtained in step S306) to the maximum bandwidth Bₗ of the L4S queue 118 (which is obtained in step S404)

$$( i . e . , \frac{{V}_{1}}{{B}_{1}} )$$

and refers to this ratio to calculate the ECN marking probability P

$$( e . g . , P = \frac{{V}_{1}}{{B}_{1}} ,$$

where P∈(0, 1)). The flow then returns to step S402 to calculate the ECN marking probability for the next period.

In another embodiment, the ECN marking circuit 128 may combine traffic information and queue monitoring result to obtain a more accurate ECN marking probability P. For example, the ECN marking probability P may be calculated using the following equation.

$$P = \frac{{L}_{1}}{L} * w 1 + \frac{{L}_{c}}{L} * w 2 + \frac{{v}_{1}}{{B}_{1}} * w 3 \qquad ( 1 )$$

In equation (1), w1, w2, and w3 represent weights of the L4S queue, the legacy queue, and the L4S sending rate, respectively, and w1+w2+w3=1. In addition, L is the total queue length of the L4S queue 118 and the legacy queue 120 (i.e., L=Lₗ+L_{c}).

Please note that values of w1, w2, and w3 can be dynamically adjusted, depending upon actual requirements. If w1=w2=0, the ECN marking circuit 128 calculates the ratio of the sending rate Vi of L4S queue 118 (which is obtained in step S306) to the maximum bandwidth Bₗ of L4S queue 118 (which is obtained in step S404)

$$\begin{matrix}( i . e . , \\ \frac{{V}_{1}}{{B}_{1}} )\end{matrix}$$

as the ECN marking probability P.

If w2=0, w1≠0, and w3≠0 (w1+w3=1), the ECN marking circuit 128 calculates the ratio of the sending rate Vₗ of the L4S queue 118 (which is obtained in step S306) to the maximum bandwidth Bₗ of the L4S queue 118 (which is obtained in step S404)

$$( i . e . , \frac{{V}_{1}}{{B}_{1}} ) ,$$

calculates the ratio of the queue length Lₗ of the L4S queue 118 (which is obtained in step S202) and the total queue length L of the L4S queue 118 and the legacy queue 120

$$( i . e . , \frac{{L}_{1}}{L} ) ,$$

and calculates a weighted sum of these two ratios as the ECN marking probability P.

If w1=0, w2≠0, and w3≠0 (w2+w3=1), the ECN marking circuit 128 calculates the ratio of the sending rate Vₗ of the L4S queue 118 (which is obtained in step S306) to the maximum bandwidth Bₗ of the L4S queue 118 (which is obtained in step S404)

$$( i . e . , \frac{{V}_{1}}{{B}_{1}} ) ,$$

calculates the ratio of the queue length L_{c} of the legacy queue 120 (which is obtained in step S202) to the total queue length L of the L4S queue 118 and the legacy queue 120

$$( i . e . , \frac{{L}_{C}}{L} ) ,$$

and calculates a weighted sum of these two ratios as the ECN marking probability P.

If w1≠0, w2≠0, and w3≠0 (w1+w2+w3=1), the ECN marking circuit 128 calculates the ratio of the sending rate Vₗ of the L4S queue 118 (which is obtained in step S306) to the maximum bandwidth Bₗ of the L4S queue 118 (which is obtained in step S404)

$$( i . e . , \frac{{V}_{1}}{{B}_{1}} ) ,$$

calculates the ratio of the queue length Lₗ of the L4S queue 118 (which is obtained in step S202) and the total queue length L of the L4S queue 118 and the legacy queue 120

$$( i . e . , \frac{{L}_{1}}{L} ) ,$$

calculates the ratio of the queue length L_{c} of the legacy queue 120 (which is obtained in step S202) to the total queue length L of the L4S queue 118 and the legacy queue 120

$$( i . e . , \frac{{L}_{c}}{L} ) ,$$

and calculates a weighted sum of these three ratios as the ECN marking probability P.

FIG. 5 is a flowchart of an ECN marking method according to an embodiment of the present invention. The ECN marking method may be performed by the ECN marking circuit 128 shown in FIG. 1. Furthermore, provided that the result is substantially the same, the steps are not required to be executed in the exact order shown in FIG. 5. In step S502, the ECN marking circuit 128 analyzes L4S packets that enter the NPU 106 during a current period (e.g., T=T_{current}), to identify each individual L4S flow. In step S504, the ECN marking circuit 128 counts L4S packets for each L4S flow, and sorts the L4S flows in a descending order according to L4S packet counts to create a flow ranking table. The flow ranking table may include an index value for each L4S flow and a corresponding L4S packet count. In step S506, the ECN marking circuit 128 selects the top N L4S flows with the highest traffic (i.e., largest L4S packet counts) from the flow ranking table according to a predetermined flow count N. In step S508, for each of the selected N L4S flows, the ECN marking circuit 128 refers to the ECN marking probability P (which is calculated in step S406) to calculate an ECN marking count m for the next period (e.g., T=Tₙₑₓₜ), that is, the number of L4S packets to be ECN-marked in the next period Tₙₑₓₜ. In the next period Tₙₑₓₜ, regarding each of the selected N L4S flows, the ECN marking circuit 128 refers to the ECN marking count m to select frontmost m L4S packets for ECN marking (step S510).

In summary, the ECN marking circuit 128 only performs ECN marking on high-traffic L4S flows (e.g., the top N L4S flows with the highest traffic in the current period), and the ECN marking of each high-traffic L4S flow is very concentrated (e.g., in the next period, only the frontmost m L4S packets will be ECN-marked). In addition, the ECN marking probabilities P of multiple L4S flows that are ECN-marked within the same period are the same.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A network packet processing device comprising:
a hardware-accelerated forwarding circuit, configured to receive a plurality of Low Latency, Low Loss, Scalable Throughput (L4S) packets from a network port, and send the plurality of L4S packets to another network port through hardware-accelerated forwarding, without intervention of a central processing unit (CPU); and
a network processing unit (NPU), configured to perform explicit congestion notification (ECN) marking on at least a portion of the plurality of L4S packets.

2. The network packet processing device of claim 1, wherein the NPU comprises:
a queue monitoring circuit, configured to monitor an L4S queue and a legacy queue to generate a monitoring result;
a traffic monitoring circuit, configured to monitor a maximum bandwidth of the another network port, wherein an update of the maximum bandwidth of the another network port depends on the monitoring result generated by the queue monitoring circuit; and
an ECN marking circuit, configured to calculate an ECN marking probability according to at least the maximum bandwidth of the another network port, and perform ECN marking on the at least a portion of the plurality of L4S packets according to the ECN marking probability.

3. The network packet processing device of claim 2, wherein the queue monitoring circuit sets the monitoring result according to a queue length of the L4S queue and a queue length of the legacy queue.

4. The network packet processing device of claim 3, wherein at least one of the queue length of the L4S queue and the queue length of the legacy queue is a non-zero value, and the monitoring result set by the queue monitoring circuit instructs the traffic monitoring circuit to update the maximum bandwidth of the another network port.

5. The network packet processing device of claim 4, wherein the traffic monitoring circuit calculates a sending rate of the L4S queue and a sending rate of the legacy queue; and in response to the monitoring result, the traffic monitoring circuit updates the maximum bandwidth of the another network port by a sum of the sending rate of the L4S queue and the sending rate of the legacy queue.

6. The network packet processing device of claim 3, wherein both of the queue length of the L4S queue and the queue length of the legacy queue are zero values, and the monitoring result set by the queue monitoring circuit instructs the traffic monitoring circuit to keep the maximum bandwidth of the another network port unchanged.

7. The network packet processing device of claim 2, wherein the ECN marking circuit calculates a maximum bandwidth of the L4S queue according to a quality of service (QoS) rule of the L4S queue and the legacy queue and the maximum bandwidth of the another network port, calculates a first ratio of a sending rate of the L4S queue to the maximum bandwidth of the L4S queue, and calculates the ECN marking probability according to at least the first ratio.

8. The network packet processing device of claim 7, wherein the ECN marking circuit further calculates a total queue length of the L4S queue and the legacy queue, and calculates a second ratio of a queue length of the L4S queue to the total queue length of the L4S queue and the legacy queue; and the ECN marking circuit calculates the ECN marking probability according to at least the first ratio and the second ratio.

9. The network packet processing device of claim 7, wherein the ECN marking circuit further calculates a total queue length of the L4S queue and the legacy queue, and calculate a second ratio of a queue length of the legacy queue to the total queue length of the L4S queue and the legacy queue; and the ECN marking circuit calculates the ECN marking probability according to at least the first ratio and the second ratio.

10. The network packet processing device of claim 2, wherein the ECN marking circuit selects a plurality of L4S flows with highest traffic according to a predetermined flow count, determines an ECN marking count according to the ECN marking probability, and for each of the plurality of L4S flows, refers to the ECN marking count to select frontmost L4S packets for ECN marking.

11. A network packet processing method comprising:
receiving a plurality of Low Latency, Low Loss, Scalable Throughput (L4S) packets from a network port;
sending the plurality of L4S packets to another network port through hardware-accelerated forwarding, without intervention of a central processing unit (CPU); and
performing, by a network processing unit (NPU), explicit congestion notification (ECN) marking on at least a portion of the plurality of L4S packets.

12. The network packet processing method of claim 11, wherein performing, by the NPU, ECN marking on the at least a portion of the plurality of L4S packets comprises:
monitoring an L4S queue and a legacy queue to generate a monitoring result;
monitoring a maximum bandwidth of the another network port, wherein an update of the maximum bandwidth of the another network port depends on the monitoring result;
calculating an ECN marking probability according to at least the maximum bandwidth of the another network; and
performing ECN marking on the at least a portion of the plurality of L4S packets according to the ECN marking probability.

13. The network packet processing method of claim 12, wherein monitoring the L4S queue and the legacy queue to generate the monitoring result comprises:
setting the monitoring result according to a queue length of the L4S queue and a queue length of the legacy queue.

14. The network packet processing method of claim 13, wherein at least one of the queue length of the L4S queue and the queue length of the legacy queue is a non-zero value, and the monitoring result instructs updating the maximum bandwidth of the another network port.

15. The network packet processing method of claim 14, wherein monitoring the maximum bandwidth of the another network port comprises:
calculating a sending rate of the L4S queue and a sending rate of the legacy queue; and
in response to the monitoring result, updating the maximum bandwidth of the another network port by a sum of the sending rate of the L4S queue and the sending rate of the legacy queue.

16. The network packet processing method of claim 13, wherein both of the queue length of the L4S queue and the queue length of the legacy queue are zero values, and the monitoring result instructs keeping the maximum bandwidth of the another network port unchanged.

17. The network packet processing method of claim 12, wherein calculating the ECN marking probability according to at least the maximum bandwidth of the another network comprises:
calculating a maximum bandwidth of the L4S queue according to a quality of service (QoS) rule of the L4S queue and the legacy queue and the maximum bandwidth of the another network port;
calculating a first ratio of a sending rate of the L4S queue to the maximum bandwidth of the L4S queue; and
calculating the ECN marking probability according to at least the first ratio.

18. The network packet processing method of claim 17, wherein calculating the ECN marking probability according to at least the maximum bandwidth of the another network further comprises:
calculating a total queue length of the L4S queue and the legacy queue; and
calculating a second ratio of a queue length of the L4S queue to the total queue length of the L4S queue and the legacy queue;
calculating the ECN marking probability according to at least the first ratio comprises:
calculating the ECN marking probability according to at least the first ratio and the second ratio.

19. The network packet processing method of claim 17, wherein calculating the ECN marking probability according to at least the maximum bandwidth of the another network further comprises:
calculating a total queue length of the L4S queue and the legacy queue; and
calculating a second ratio of a queue length of the legacy queue to the total queue length of the L4S queue and the legacy queue;
calculating the ECN marking probability according to at least the first ratio comprises:
calculating the ECN marking probability according to at least the first ratio and the second ratio.

20. The network packet processing method of claim 12, wherein performing ECN marking on the at least a portion of the plurality of L4S packets according to the ECN marking probability comprises:
selecting a plurality of L4S flows with highest traffic according to a predetermined flow count;
determining an ECN marking count according to the ECN marking probability; and
for each of the plurality of L4S flows, referring to the ECN marking count to select frontmost L4S packets for ECN marking.
